(19) United States
(12) Patent Application Publication
(10) Pub. No.: US 2004/0230534 A1
(43) Pub. Date: Nov. 18, 2004

(54) Encrypted credit application processing system and method

(75) Inventor: David McGough, Addison, TX (US)

Correspondence Address: THOMPSON & KNIGHT L.L.P., PATENT PROSECUTION DEPARTMENT, 98 SAN JACINTO BLVD., SUITE 1900, AUSTIN, TX, 78701, US

(73) Assignee: Digital Matrix Systems, Inc.

(21) Appl. No.: 10/435,894

(22) Filed: May 12, 2003

(51) Int. Cl. G06F 17/60

(52) U.S. Cl. 705/64

(57) ABSTRACT

A method for processing credit applications, including several steps. A credit request is received including consumer identification data. Credit report data is received corresponding to the consumer identification data. The credit report data is organized to form formatted credit report data. Consumer identification data is removed from the formatted credit report data and credit request data to form anonymized credit data. Pre-defined application data, credit report data, and credit request data characteristics are appended. The anonymized credit data is encrypted to form an encrypted credit file. The encrypted credit file is transmitted to a lending institution. A response is received indicating credit approval corresponding to the encrypted credit file.

### FIELD OF THE INVENTION

The present invention relates to a system and a method for processing credit applications. More specifically, the invention relates to a system and a method for processing credit applications wherein the consumer's identification is removed from credit application, and the remaining information is organized in a predetermined fashion, encrypted, and transmitted to a financial institution for approval or disapproval.

### BACKGROUND OF THE INVENTION

Systems and methods for the automatic review of credit applications are well known. Typically in such systems and methods, credit information is retrieved from credit bureaus, and credit history and transaction information are transmitted to financial institutions for review. In some such systems and methods, information about the consumer's credit history is organized and formatted in a predetermined fashion before transmittal. The financial institution then processes this information and decides whether to approve or disapprove of the transaction.

Several of these automatic credit application review systems and methods have been patented. For example, U.S. Pat. No. 5,930,776, to Dykstra, et al., is for an automated credit evaluation and loan processing system. In this system, a potential borrower accesses the system through remote terminal, which is authenticated by a simple call-back, PIN protocol. Information about the borrower is transmitted to a host computer, a credit report is retrieved and credit scoring is used to approve or decline the loan at the host computer.

Similarly, U.S. Pat. No. 5,878,403 to DeFrancesco, et al., is for an automated credit application and routing system. Applications are received at a central processor from remote terminals, where they are forwarded to financial institutions along with credit bureau reports. Decisions from the financial institutions are forwarded back to the central processor.

U.S. Pat. No. 5,274,547, to Zoffel, et al., is for a system for collating, formatting and transmitting credit reports. Credit reports are retrieved from multiple credit bureaus. The information in the bureau reports are compared and the best data is collected into a formatted credit report. The formatted credit report is then transmitted via modem to a customer.

Consumers also have a legitimate interest in keeping their names and identities private during the initial stages of the credit application process. In addition to the consumer's basic privacy interest, a person's name alone may convey certain information such as gender and ethnicity that is, by law, extraneous to the lending transaction. Normally, credit applications, including those submitted electronically, include the applicant's name for purposes of tracking, but that information is not vital to the initial credit application process and in fact may be a hindrance to efficient, reliable, and trustworthy processing. Even if a lending institution's decision making is in fact entirely in keeping with the requirements of the Fair Lending Act and similar requirements, the fact that this extraneous information is part of the application may result in false accusations of bias or discrimination.

### SUMMARY OF THE INVENTION

The present invention includes a method and a system for processing credit applications, wherein credit data is “anonymized,” appended with specific transactional information, organized into a predetermined format, and encrypted, forming a “summary packet”. This summary packet is then transmitted to a lending institution. At the lending institution, the application can be decrypted and processed and the lending decision returned to the requestor.

Alternatively, the present invention includes a method for processing credit applications, including several steps. A credit request is received including consumer identification data. Credit report data is received corresponding to the consumer identification data. The credit report data is organized to form formatted credit report data. Consumer identification data is removed from the formatted credit report data and credit request data to form anonymized credit data. Pre-defined application data, credit report data, and credit request data characteristics are appended. The anonymized credit data is encrypted to form an encrypted credit file. The encrypted credit file is transmitted to a lending institution. A response is received indicating credit approval corresponding to the encrypted credit file.

Further features and advantages of the invention will become apparent from the following detailed description and accompanying drawings.

### BRIEF DESCRIPTION OF THE DRAWINGS

Other objects, advantages, features and characteristics of the present invention, as well as methods, operation and functions of related elements of structure, and the combination of parts and economies of manufacture, will become apparent upon consideration of the following description and claims with reference to the accompanying drawings, all of which form a part of this specification, wherein like reference numerals designate corresponding parts in the various figures, and wherein:

FIG. 1 shows a credit-processing system diagram, according to an embodiment of the present invention.

FIG. 2 depicts a different view of a similar credit-processing system, according to an embodiment of the present invention.

FIG. 3 illustrates a flowchart of a method for processing credit applications, according to an embodiment of the present invention.

### DETAILED DESCRIPTION OF PREFERRED EMBODIMENTS

In the following detailed description of the preferred embodiments, reference is made to the accompanying drawings, which form a part hereof, and in which is shown by way of illustration specific preferred embodiments in which the invention may be practiced. These embodiments are described in sufficient detail to enable those skilled in the art to practice the invention, and it is to be understood that other embodiments may be utilized and that logical, mechanical, electrical and software changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

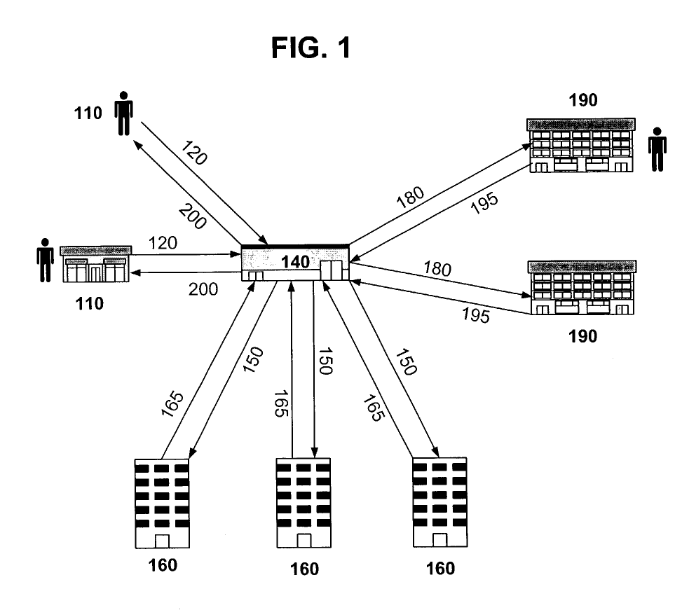

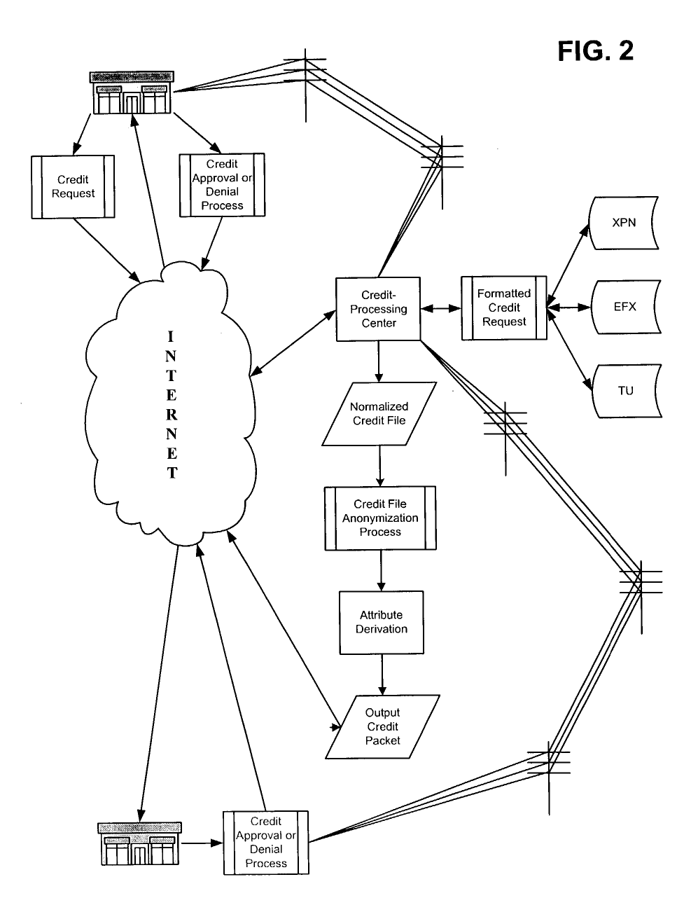

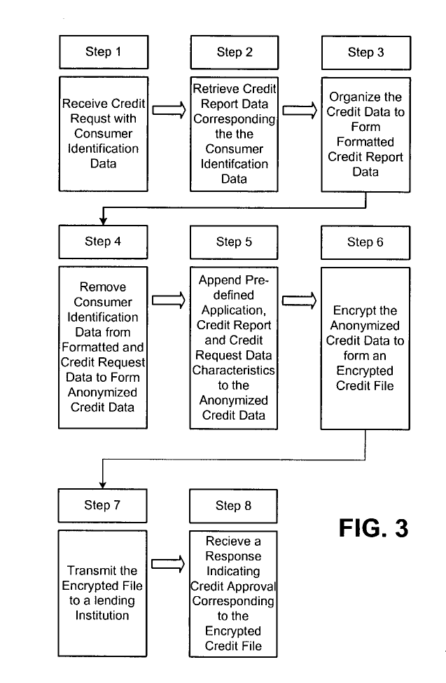

FIG. 1 depicts a credit processing system. FIG. 2 is a different depiction of a similar system. A credit originator (110) creates a credit request (120) that is sent to a credit-processing center (140). FIG. 3 depicts a method for processing credit applications by the credit-processing center (140). The credit request will typically include consumer identification data, a transaction identifier such as an identification number, and transaction data such as credit product, terms, transaction amount, collateral, interest rates, deposits, down payments, possible payment options. Table 1, located in the Appendix, below, contains a request for credit layout example. The consumer identification data could be the consumer's name, social security number or any other data used by a credit bureau to identify a consumer. The originator (110) of the credit request (120) may be a consumer, a credit-processing center, a financial institution, institutions in a service bureau arrangement for credit transactions, or institutions wishing to market or broker applications of creditworthy consumers. Other originators could be institutional or consumer auction environments of credit applications, institutions using a type of transactional clearing house, or the consumer themselves wishing to shop their credit transaction applications to a number of institutions while remaining anonymous.

The transmission of the credit request (120) from the originator (110) to the credit-processing center (140) is preferably made through standard communication channels, such as a telephone call, fax or Internet. Other forms of communication could be used, as will be apparent to one having skill in the art, as would be appropriate to the parties.

The credit-processing center (140) receives the credit request (120) and extracts consumer identification data from the credit request (120). Using the consumer identification data, the credit-processing center (140) requests one or more credit reports (150) associated with the consumer identified by the consumer identification data from one or more credit bureaus (160). Credit bureaus provide credit information about particular consumers and presently include such bureaus as Experian, Equifax and Trans Union. The requests are preferably made by a secure direct connection between the credit-processing center, but other forms of transmission could be used, as appropriate. The credit bureaus (160) transmit the credit reports (165) of credit report data for the identified consumer back to the credit-processing center (140), using an appropriate communication channel.

The credit-processing center (140) arranges the data in the credit reports into a predetermined format of formatted credit report data. Table 2, located in the Appendix, below, contains an example of a standard, predetermined format for an anonymized credit request. Other formats could be used, as will be apparent to those skilled in the art. Formatting preferably includes a “normalization” of the credit data received from one or more of the credit bureaus into a standardized method of representing the data uniformly, so that the normalized data is transparent with regard to the data source. Table 3, located in the Appendix, below, contains a “normalized” credit report layout example. The data is then categorized, summarized, or used in calculations to create a set of predefined attributes. These attributes provide a consistent representation of the credit information received.

The credit-processing center (140) compiles the credit request (120) and the formatted credit reports (165) to form a compiled credit file. The credit-processing center (140) then anonymizes the compiled credit file to form an anonymized compiled credit file. In the alternative, the credit-processing center (140) would anonymize the credit request (120) and formatted credit reports (165) individually, and subsequently compile the anonymized credit request and anonymized credit reports to form an anonymized compiled credit file.

The “anonymization” process removes all customer identifiable data from the compiled credit file. Customer identifiable data is any information that could reveal the identity of the customer, such as the customer's name, address, social security number, driver's license number, taxpayer identification number, application data, debit transaction history, public record information, retail company, identification, legal actions, collection activities or similar data.

The credit-processing center encrypts the anonymized compiled credit file using an Advanced Encryption Standard (AES) FIPS-approved cryptographic algorithm that can be used to protect electronic data. The AES algorithm is a symmetric block cipher that can encrypt (encipher) and decrypt (decipher) information. Encryption converts this anonymized compiled credit file to an unintelligible form (ciphertext) to create the encrypted summary packet of credit and application data. The encrypted summary packet is transmitted (180) by the credit-processing center (140) to one or more lending institutions (190). The ciphertext file may be transmitted to the lending institution by standard communication techniques such as the Internet, intranet, telephone, wireless communication, or facsimile or other similar techniques. The method used to convey the encrypted summary packet may depend primarily on the type of transaction requested. If the transaction were a credit application that is to be bid out to multiple lending institutions (190), the primary transmission method would preferably be the Internet. The encrypted summary packet is sent (180) to the pre-defined IP addresses of lending institutions (190) that monitor or “listen” for these unsolicited transactions. The credit-processing center (140) generates these parallel transmissions of encrypted summary packets (180) from a list of lending institutions (190) interested in receiving those particular transaction types.

The lending institution (190) decrypts the encrypted summary packet (180) to recover the anonymized compiled credit file. The decryption process will convert the ciphertext back to its original form called plaintext. The AES algorithm is capable of using cryptographic keys of 128, 192, and 256 bits to encrypt and decrypt data in blocks of 128 bits. Other forms of encryption could be used, as will be apparent to one having skill in the art, as would be appropriate to the parties involved in the transactions.

Using the anonymized compiled credit file, the lending institutions use their individual credit evaluation systems to evaluate the creditworthiness of a hypothetical consumer for the proposed transaction. The evaluation is typically done using scorecards and/or decision tree scenarios that are standard in the credit evaluation field, or proprietary to the particular lending institution. Loan origination systems, credit decisioning systems, loan application scoring/processing systems or specialty platforms would be coded to accept the formatted credit information and could therefore analyze that packet without the need for further translation.

Co-ops could easily share the encrypted packets for multiple product decisioning as well as multiple lending institution offerings. Scoring and decisioning on these credit transactions would provide cross-selling types of multiple decisioning from a single consumer generated transaction request. The consumer generating the initial request could exclude themselves from such cross-selling types of analysis by an application flag within the summary packet.

If the lending institution (190) determines that the hypothetical applicant would be an acceptable risk by that lending institution's standards and would be willing to accept any conditional terms outlined in the anonymized compiled credit file, the lending institution (190) transmits a response (195) to the credit-processing center (140) that the lending institution (190) would be willing to consider accepting the proposed transaction. Such notification may be via the Internet, intranet, telephone, wireless communication, or facsimile. This may be expedited by transmitting the transaction identifier associated with the credit request and the acceptance. If a lending institution would not accept the proposed transaction, then no action is taken by the credit-processing center (140). Only the acceptance of transactions generates a response (200) from the credit-processing center (140) to the credit originator (110). Multiple lending institutions (190) accepting the terms of an individual summary packet can be handled by assigning priority by first response or on a right of first refusal basis.

Although the invention has been described with a certain degree of particularity, it should be recognized that elements thereof may be altered by persons skilled in the art without departing from the spirit and scope of the invention. The invention is limited only by the following claims and their equivalents.

### APPENDIX

TABLE 1
Request for Credit Layout Example.

| Input segment: “IN” | | (Type, Size) | Field Description |
|---|---|---|---|
| 1 | INsegid | Text, 4 | set to “IN02” |
| 2 | INsourcesegid | Text, 10 | Company Source ID Number |
| 3 | INreqdate | Date, 8 | Date of Request |
| 4 | INbureaurequested | Text, 9 | Bureaus Requested |
| | | | (i.e. EFX, TU, XPN) |
| 5 | INmergeflag | Text, 1 | Merge = 1, Non-Merged |
| | | | Reports = 2 |
| 6 | INtracking | Text, 15 | Tracking ID Number |
| 7 | INname | Text, 40 | Applicant's Full Name |
| 8 | INappidnum | Text, 9 | Applicant's ID Number |
| 9 | INcoapp | Text, 40 | Co-Applicant's Full Name |
| 10 | INcoappidnum | Text, 9 | Co-Applicant's ID Number |
| 11 | INstreet | Text, 35 | Street Name |
| 12 | INcity | Text, 50 | City, State, Province, |
| | | | Mail Code & Zip code |
| 13 | INuser | Text, 32 | User ID of requestor |
| | | | (User name used to |
| | | | select printer, |
| 14 | INappid | Text, 20 | Application ID number |
| 15 | INtxnid | Text, 20 | Transaction ID Number |
| 16 | INproduct | Text, 35 | Loan Product Name |
| 17 | INterms | Text, 50 | Proposed Terms of Loan |
| 18 | INtxnamount | Amount, 12 | Loan Amount Requested |
| 19 | INcollateral | Text, 35 | Collateral Offered |
| 20 | INvin | Text, 20 | Vehicle ID Number |
| 21 | INapr | Text, 12 | Annual Percentage Rate |
| 22 | INdownpay | Amount, 12 | Down Payment Amount |
| 23 | INpayamount | Amount, 12 | Regular Payment Amount |
| 24 | INpayoption | Text, 50 | Payment Option Text |
| 25 | INinstype1 | Text, 35 | Insurance Type 1 |
| 26 | INinsrate1 | Text, 9 | Insurance Rate 1 |
| 27 | INinstype2 | Text, 35 | Insurance Type 2 |
| 28 | INinsrate2 | Text, 9 | Insurance Rate 2 |
| 29 | INballoonamt | Amount, 12 | Balloon Amount |
| 30 | INballoondate | Date, 8 | Balloon Date |
| 31 | INappincome | Amount, 12 | Applicant's Income |
| 32 | INappemployer | Text, 35 | Applicant's Employer |
| 33 | INappempaddr | Text, 50 | Applicant's Employer |
| | | | Address (City, State, |
| 34 | INappempphone | Text, 15 | Applicant's Employer Phone |
| 35 | INcoappincome | Amount, 12 | Co-Applicant's Income |
| 36 | INcoappemployer | Text, 35 | Co-Applicant's Employer |
| 37 | INcoappempaddr | Text, 50 | Co-Applicant's Employer |
| | | | Address (City, State, Pro- |
| | | | vince, Mail Code & Zip code) |
| 38 | INcoappempphone | Text, 15 | Co-Applicant's Employer Phone |
| 39 | INcototothincome | Amount, 12 | Total Additional Income for |
| | | | Consideration |
| 40 | INcootherincsource | Text, 35 | Source of Other Income |
| 41 | INuserfield1 | Text, 35 | User Defined Field #1 |
| 42 | INuserfield2 | Text, 35 | User Defined Field #2 |
| 43 | INuserfield3 | Text, 35 | User Defined Field #3 |
| 44 | INuserfield4 | Text, 35 | User Defined Field #4 |
| 45 | INuserfield5 | Text, 35 | User Defined Field #5 |
| 46 | INuserfield6 | Text, 35 | User Defined Field #6 |

IN: Input Segment - The input segment contains application information and the applicant information used to pull the credit report.

TABLE 2
“Anonymized” Credit Packet Layout Example

| Input segment: “IN” | | (Type, Size) | Field Description |
|---|---|---|---|
| 1 | INsegid | Text, 4 | Set to “IN02” |
| 2 | INsourcesegid | Text, 10 | Company Source ID Number |
| 3 | INreqdate | Date, 8 | Date of Request |
| 4 | Inbureaurequested | Text, 9 | Bureaus Requested |
| | | | (i.e. EFXTU XPN) |
| 5 | INmergeflag | Text, 1 | Merge = 1, Non-Merged |
| | | | Reports = 2 |
| 6 | INtracking | Text, 15 | Tracking ID Number |
| 7 | INuser | Text, 32 | User ID of requestor (User |
| | | | name used to select |
| | | | printer, account, etc.) |
| 8 | INappid | Text, 20 | Application ID number |
| 9 | INtxnid | Text, 20 | Transaction ID Number |
| 10 | INproduct | Text, 35 | Loan Product Name |
| 11 | INterms | Text, 50 | Proposed Terms of Loan |
| 12 | INtxnamount | Amount, 12 | Loan Amount Requested |
| 13 | INcollateral | Text, 35 | Collateral Offered |
| 14 | Invin | Text, 20 | Vehicle ID Number |
| 15 | Inapr | Text, 12 | Annual Percentage Rate |
| 16 | INdownpay | Amount, 12 | Down Payment Amount |
| 17 | INpayamount | Amount, 12 | Regular Payment Amount |
| 18 | INpayoption | Text, 50 | Payment Option Text |
| 19 | INinstypel | Text, 35 | Insurance Type 1 |
| 20 | INinsratel | Text, 9 | Insurance Rate 1 |
| 21 | INinstype2 | Text, 35 | Insurance Type 2 |
| 22 | INinsrate2 | Text, 9 | Insurance Rate 2 |
| 23 | INballoonamt | Amount, 12 | Balloon Amount |
| 24 | INballoondate | Date, 8 | Balloon Date |
| 25 | INappincome | Amount, 12 | Applicant's Income |
| 26 | INcoappincome | Amount, 12 | Co-Applicant's Income |
| 27 | INcototothincome | Amount, 12 | Total Additional Income |
| | | | for Consideration |
| 28 | INcootherincsource | Text, 35 | Source of Other Income |
| 29 | INuserfield1 | Text, 35 | User Defined Field #1 |
| 30 | INuserfield2 | Text, 35 | User Defined Field #2 |
| 31 | INuserfield3 | Text, 35 | User Defined Field #3 |
| 32 | INuserfield4 | Text, 35 | User Defined Field #4 |
| 33 | INuserfield5 | Text, 35 | User Defined Field #5 |
| 34 | INuserfield6 | Text, 35 | User Defined Field #6 |

| Consumer Information Segment: CI | | Type/Size |
|---|---|---|
| 1 | SUCIsegid | Text/4 |
| 2 | SUCIsourcesegid | Text/4 |
| 3 | SUCIbureauhitlevelid | Text/10 |
| 4 | SUCIdedupflag | Num/1 |
| 5 | SUCIdedupids | Text/250 |
| 6 | SUCIcategory | Text/2 |
| 7 | SUCI001 | Num/11 |
| 8 | SUCI002 | Num/11 |
| 9 | SUCI003 | Num/11 |
| 10 | SUCI004 | Num/11 |
| 11 | SUCI005 | Num/11 |
| 12 | SUCI006 | Num/11 |
| 13 | SUCI007 | Num/11 |
| 14 | SUCI008 | Num/11 |
| 15 | SUCI009 | Num/11 |
| 16 | SUCI010 | Num/11 |
| 17 | SUCI011 | Num/11 |
| 18 | SUCI012 | Num/11 |
| 19 | SUCI013 | Num/11 |
| 20 | SUCI014 | Num/11 |
| 21 | SUCI015 | Num/11 |
| 22 | SUCI016 | Num/11 |
| 23 | SUCI017 | Num/11 |
| 24 | SUCI018 | Num/11 |
| 25 | SUCI019 | Num/11 |
| 26 | SUCI020 | Num/11 |
| 27 | SUCI021 | Num/11 |
| 28 | SUCI022 | Num/11 |
| 29 | SUCI023 | Num/11 |
| 30 | SUCI024 | Num/11 |
| 31 | SUCI025 | Num/11 |
| 32 | SUCI026 | Num/11 |
| 33 | SUCI027 | Num/11 |
| 34 | SUCI028 | Num/11 |
| 35 | SUCI029 | Num/11 |
| 36 | SUCI030 | Num/11 |
| 37 | SUCI031 | Num/11 |
| 38 | SUCI032 | Num/11 |
| 39 | SUCI033 | Num/11 |
| 40 | SUCI034 | Num/11 |
| 41 | SUCI035 | Num/11 |
| 42 | SUCI036 | Num/11 |
| 43 | SUCI037 | Num/11 |
| 44 | SUCI038 | Num/11 |
| 45 | SUCI039 | Num/11 |
| 46 | SUCI040 | Num/11 |
| 47 | SUCI041 | Num/11 |
| 48 | SUCI042 | Num/11 |
| 49 | SUCI043 | Num/11 |
| 50 | SUCI044 | Num/11 |
| 51 | SUCI045 | Num/11 |
| 52 | SUCI046 | Num/11 |
| 53 | SUCI047 | Num/11 |
| 54 | SUCI048 | Num/11 |
| 55 | SUCI049 | Num/11 |
| 56 | SUCI050 | Num/11 |
| 57 | SUCI051 | Num/11 |
| 58 | SUCI052 | Num/11 |
| 59 | SUCI053 | Num/11 |
| 60 | SUCI054 | Num/11 |
| 61 | SUCI055 | Num/11 |
| 62 | SUCI056 | Num/11 |
| 63 | SUCI057 | Num/11 |
| 64 | SUCI058 | Num/11 |
| 65 | SUCI059 | Num/11 |
| 66 | SUCI060 | Num/11 |
| 67 | SUCI061 | Num/11 |
| 68 | SUCI062 | Num/11 |
| 69 | SUCI063 | Num/11 |
| 70 | SUCI064 | Num/11 |
| 71 | SUCI065 | Num/11 |
| 72 | SUCI066 | Num/11 |
| 73 | SUCI067 | Num/11 |
| 74 | SUCI068 | Num/11 |
| 75 | SUCI069 | Num/11 |
| 76 | SUCI070 | Num/11 |
| 77 | SUCI071 | Num/11 |
| 78 | SUCI072 | Num/11 |
| 79 | SUCI073 | Num/11 |
| 80 | SUCI074 | Num/11 |
| 81 | SUCI075 | Num/11 |
| 82 | SUCI076 | Num/11 |
| 83 | SUCI077 | Num/11 |
| 84 | SUCI078 | Num/11 |
| 85 | SUCI079 | Num/11 |
| 86 | SUCI080 | Num/11 |
| 87 | SUCI081 | Num/11 |
| 88 | SUCI082 | Num/11 |
| 89 | SUCI083 | Num/11 |
| 90 | SUCI084 | Num/11 |
| 91 | SUCI085 | Num/11 |
| 92 | SUCI086 | Num/11 |
| 93 | SUCI087 | Num/11 |
| 94 | SUCI088 | Num/11 |
| 95 | SUCI089 | Num/11 |
| 96 | SUCI090 | Num/11 |
| 97 | SUCI091 | Num/11 |
| 98 | SUCI092 | Num/11 |
| 99 | SUCI093 | Num/11 |
| 100 | SUCI094 | Num/11 |
| 101 | SUCI095 | Num/11 |
| 102 | SUCI096 | Num/11 |
| 103 | SUCI097 | Num/11 |
| 104 | SUCI098 | Num/11 |
| 105 | SUCI099 | Num/11 |
| 106 | SUCI100 | Num/11 |
| 107 | SUCI101 | Num/11 |
| 108 | SUCI102 | Num/11 |
| 109 | SUCI103 | Num/11 |
| 110 | SUCI104 | Num/11 |
| 111 | SUCI105 | Num/11 |
| 112 | SUCI106 | Num/11 |
| 113 | SUCI107 | Num/11 |
| 114 | SUCI108 | Num/11 |
| 115 | SUCI109 | Num/11 |
| 116 | SUCI110 | Num/11 |
| 117 | SUCI111 | Num/11 |
| 118 | SUCI112 | Num/11 |
| 119 | SUCI113 | Num/11 |
| 120 | SUCI114 | Num/11 |
| 121 | SUCI115 | Num/11 |
| 122 | SUCI116 | Num/11 |
| 123 | SUCI117 | Num/11 |
| 124 | SUCI118 | Num/11 |
| 125 | SUCI119 | Num/11 |
| 126 | SUCI120 | Num/11 |
| 127 | SUCI121 | Num/11 |
| 128 | SUCI122 | Num/11 |
| 129 | SUCI123 | Num/11 |
| 130 | SUCI124 | Num/11 |
| 131 | SUCI125 | Num/11 |
| 132 | SUCI126 | Num/11 |
| 133 | SUCI127 | Num/11 |
| 134 | SUCI128 | Num/11 |
| 135 | SUCI129 | Num/11 |
| 136 | SUCI130 | Num/11 |
| 137 | SUCI131 | Num/11 |
| 138 | SUCI132 | Num/11 |
| 139 | SUCI133 | Num/11 |
| 140 | SUCI134 | Num/11 |
| 141 | SUCI135 | Num/11 |
| 142 | SUCI136 | Num/11 |
| 143 | SUCI137 | Num/11 |
| 144 | SUCI138 | Num/11 |
| 145 | SUCI139 | Num/11 |
| 146 | SUCI130 | Num/11 |
| 147 | SUCI141 | Num/11 |
| 148 | SUCI142 | Num/11 |
| 149 | SUCI143 | Num/11 |
| 150 | SUCI144 | Num/11 |
| 151 | SUCI145 | Num/11 |
| 152 | SUCI146 | Num/11 |
| 153 | SUCI147 | Num/11 |
| 154 | SUCI148 | Num/11 |
| 155 | SUCI149 | Num/11 |
| 156 | SUCI150 | Num/11 |
| 157 | SUCI151 | Num/11 |
| 158 | SUCI152 | Num/11 |
| 159 | SUCI153 | Num/11 |
| 160 | SUCI154 | Num/11 |
| 161 | SUCI155 | Num/11 |
| 162 | SUCI156 | Num/11 |
| 163 | SUCI157 | Num/11 |
| 164 | SUCI158 | Num/11 |
| 165 | SUCI159 | Num/11 |
| 166 | SUCI160 | Num/11 |
| 167 | SUCI161 | Num/11 |
| 168 | SUCI162 | Num/11 |
| 169 | SUCI163 | Num/11 |
| 170 | SUCI164 | Num/11 |
| 171 | SUCI165 | Num/11 |
| 172 | SUCI166 | Num/11 |
| 173 | SUCI167 | Num/11 |
| 174 | SUCI168 | Num/11 |
| 175 | SUCI169 | Num/11 |
| 176 | SUCI170 | Num/11 |
| 177 | SUCI171 | Num/11 |
| 178 | SUCI172 | Num/11 |
| 179 | SUCI173 | Num/11 |
| 180 | SUCI174 | Num/11 |
| 181 | SUCI175 | Num/11 |
| 182 | SUCI176 | Num/11 |
| 183 | SUCI177 | Num/11 |
| 184 | SUCI178 | Num/11 |
| 185 | SUCI179 | Num/11 |
| 186 | SUCI180 | Num/11 |
| 187 | SUCI181 | Num/11 |
| 188 | SUCI182 | Num/11 |
| 189 | SUCI183 | Num/11 |
| 190 | SUCI184 | Num/11 |
| 191 | SUCI185 | Num/11 |
| 192 | SUCI186 | Num/11 |
| 193 | SUCI187 | Num/11 |
| 194 | SUCI188 | Num/11 |
| 195 | SUCI189 | Num/11 |
| 196 | SUCI190 | Num/11 |
| 197 | SUCI191 | Num/11 |
| 198 | SUCI192 | Num/11 |
| 199 | SUCI193 | Num/11 |
| 200 | SUCI194 | Num/11 |
| 201 | SUCI195 | Num/11 |
| 202 | SUCI196 | Num/11 |
| 203 | SUCI197 | Num/11 |
| 204 | SUCI198 | Num/11 |
| 205 | SUCI199 | Num/11 |
| 206 | SUCI200 | Num/11 |
| 207 | SUCI201 | Num/11 |
| 208 | SUCI202 | Num/11 |
| 209 | SUCI203 | Num/11 |
| 210 | SUCI204 | Num/11 |
| 211 | SUCI205 | Num/11 |

| | |
|---|---|
| Checksum Segment: CK | Type/Size |

| | | |
|---|---|---|
| 1 | CKsegid | Text/4 |
| 2 | CKnosegments | Num/4 |
| 3 | CKnocharacters | Num/5 |
| 4 | CKchecksum | Num/13 |

IN: Input Segment - The input segment contains applicant information and the information that was used to pull the credit report.

TABLE 3
“Normalized” Credit Report Layout Example

| Input segment: “IN” | | (Type, Size) | Field Description |
|---|---|---|---|
| 1 | INsegid | Text, 4 | Set to “IN02” |
| 2 | INsourcesegid | Text, 10 | Company Source ID Number |
| 3 | INreqdate | Date, 8 | Date of Request |
| 4 | INbureaurequested | Text, 9 | Bureaus Requested (i.e. |
| | | | EFXTU XPN) |
| 5 | INmergeflag | Text, 1 | Merge = 1, Non-Merged |
| | | | Reports = 2 |
| 6 | INtracking | Text, 15 | Tracking ID Number |
| 7 | INuser | Text, 32 | User ID of requestor |
| | | | (User name used to |
| | | | select printer, |
| | | | account, etc.) |
| 8 | INappid | Text, 15 | Application ID number |
| 9 | INtxnid | Text, 15 | Transaction ID Number |
| 10 | INproduct | Text, 35 | Loan Product Name |
| 11 | INterms | Text, 50 | Proposed Term of Loan |
| 12 | INtxnamount | Amount, 12 | Loan Amount Requested |
| 13 | INcollateral | Text, 35 | Collateral Offered |
| 14 | INapr | Text, 12 | Annual Percentage Rate |
| 15 | INdownpay | Amount, 12 | Down Payment Amount |
| 16 | INpayamount | Amount, 12 | Regular payment Amount |
| 17 | INpayoption | Text, 50 | Payment Option Text |
| 18 | INinstypel | Text, 35 | Insurance Type 1 |
| 19 | INinsratel | Text, 9 | Insurance Rate 1 |
| 20 | INinstype2 | Text, 35 | Insurance Type 2 |
| 21 | INinsrate2 | Text, 9 | Insurance Rate 2 |
| 22 | INballoonamt | Amount, 12 | Balloon Amount |
| 23 | INballoondate | Date, 8 | Balloon Date |
| 24 | INappincome | Amount, 12 | Applicant's Income |
| 25 | INcoappincome | Amount, 12 | Co-Applicant's Income |
| 26 | INcototothincome | Amount, 12 | Total Additional Income for |
| | | | Consideration |
| 27 | INcootherincsource | Text, 35 | Source of Other Income |
| 28 | INuserfield1 | Text, 35 | User Defined Field #1 |
| 29 | INuserfield2 | Text, 35 | User Defined Field #2 |
| 30 | INuserfield3 | Text, 35 | User Defined Field #3 |
| 31 | INuserfield4 | Text, 35 | User Defined Field #4 |
| 32 | TNuserfield5 | Text, 35 | User Defined Field #5 |
| 33 | INuserfield6 | Text, 35 | User Defined Field #6 |

| Alias Segment: AK | | Type/Size |
|---|---|---|
| 1 | Aksegid | Text/4 |
| 2 | Aksourcesegid | Text/4 |
| 3 | Akbureauhitlevelid | Text/10 |
| 4 | AKdedupflag | Num/1 |
| 5 | AKdedupids | Text/250 |
| 6 | AKfirst | Text/15 |
| 7 | AKmiddle | Text/15 |
| 8 | AKlast | Text/25 |
| 9 | AKprefix | Text/3 |
| 10 | AKsuffix | Text/3 |
| 11 | AKnamesource | Text/1 |
| 12 | AKnameind | Text/1 |
| 13 | AKgender | Text/1 |
| 14 | AKage | Text/3 |
| 15 | AKdatebirth | Date/8 |
| 16 | AKssnverif | Text/1 |
| 17 | AKssn | SSN/9 |
| 18 | AKssnno | Text/2 |
| 19 | AKsourceind | Text/1 |
| 20 | AKspouse | Text/15 |
| 21 | AKsssn | SSN/9 |

| Bank Account Segment: BA | | Type/Size |
|---|---|---|
| 1 | BAsegid | Text/4 |
| 2 | BAsourcesegid | Text/4 |
| 3 | BAbureauhitlevelid | Text/10 |
| 4 | BAdedupflag | Num/1 |
| 5 | BAdedupids | Text/250 |
| 6 | BAmember | Text/10 |
| 7 | BAdaterep | Date/8 |
| 8 | BAdateopened | Date/8 |
| 9 | BAacctype | Text/2 |
| 10 | BAamount | Text/15 |
| 11 | BAhold | Text/2 |
| 12 | BAcomment | Code=Text/255 |
| 13 | BAcomment2 | Code=Text/255 |
| 14 | BAfbcode | Text/1 |

| Bureau Segment: BU | | Type/Size |
|---|---|---|
| 1 | BUsegid | Text/4 |
| 2 | BUsourcesegid | Text/4 |
| 3 | BUbureauhitlevelid | Text/10 |
| 4 | BUdedupflag | Num/1 |
| 5 | BUdedupids | Text/250 |
| 6 | BUcode | Text/4 |
| 7 | BUname | Text/50 |
| 8 | BUstreet | Text/128 |
| 9 | BUstreet2 | Text/50 |
| 10 | BUcityonly | Text/64 |
| 11 | BUstate | Text/2 |
| 12 | BUzip | Text/10 |
| 13 | BUphone | Text/22 |
| 14 | BUphonelang | Text/1 |

| Address Segment: CA | | Type/Size |
|---|---|---|
| 1 | CAsegid | Text/4 |
| 2 | CAsourcesegid | Text/4 |
| 3 | CAbureauhitlevelid | Text/10 |
| 4 | CAdedupflag | Num/1 |
| 5 | CAdedupids | Text/250 |
| 6 | CAqualifier | Text/1 |
| 7 | CAparseind | Text/1 |
| 8 | CAstreet | Text/72 |
| 9 | CAhouseno | Text/10 |
| 10 | CApredirect | Text/2 |
| 11 | CAstreetname | Text/27 |
| 12 | CApostdirect | Text/2 |
| 13 | CAstreettype | Text/26 |
| 14 | CAapart | Text/5 |
| 15 | CAcityonly | Text/72 |
| 16 | CAstate | Text/2 |
| 17 | CAzip | Text/10 |
| 18 | CAcountycode | Text/2 |
| 19 | CAstatecode | Text/2 |
| 20 | CAmsacode | Text/4 |
| 21 | CAdwelltype | Text/1 |
| 22 | CAdatesince | Date/8 |
| 23 | CAstatus | Text/1 |
| 24 | CAdaterep | Date/8 |
| 25 | CAsourceind | Text/1 |
| 26 | CAadrvarind | Text/1 |
| 27 | CAreportno | Text/2 |
| 28 | CAlastsubcode | Text/7 |
| 29 | CAcensusgeo | Text/7 |
| 30 | CAphone | Text/10 |
| 31 | CAphoneext | Text/5 |
| 32 | CAphonesource | Text/1 |
| 33 | CAphonequal | Text/1 |
| 34 | CAphonetype | Text/2 |
| 35 | CAphoneavail | Text/10 |
| 36 | CAphonedate | Date/8 |
| 37 | CAformer | Num/1 |
| | | 0 = current |
| | | 1 = former |
| | | 2 = 2^{nd} former |

| Consumer Statement Segment: CS | | Type/Size |
|---|---|---|
| 1 | CSsegid | Text/4 |
| 2 | CSsourcesegid | Text/4 |
| 3 | CSbureauhitlevelid | Text/10 |
| 4 | CSdedupflag | Num/1 |
| 5 | CSdedupids | Text/250 |
| 6 | Csstatementmatchid | Text/75 |
| | (to associate a CS | |
| | segment with other | |
| | segments if filled in) | |
| 7 | CSsubcode | Text/24 |
| 8 | CSaccount | Text/40 |
| 9 | CStype | Text/2 |
| 10 | Csstatement (blanks | Text/5000 |
| | will be trimmed) | |
| 11 | CSdaterep | Date/8 |
| 12 | CSpurgedate | Date/8 |

| Decode Segment: DC | | Type/Size |
|---|---|---|
| 1 | DCsegid | Text/4 |
| 2 | DCsourcesegid | Text/4 |
| 3 | DCbureauhitlevelid | Text/10 |
| 4 | DCdedupflag | Num/1 |
| 5 | DCdedupids | Text/250 |
| 6 | DCsubcode | Text/40 |
| 7 | DCsubtel | Text/40 |
| 8 | DCsubphoneext | Text/5 |
| 9 | DCsubphonesource | Text/1 |
| 10 | DCsubphonequal | Text/1 |
| 11 | DCsubphonetype | Text/2 |
| 12 | DCsubphoneavail | Text/10 |
| 13 | DCsubname | Text/80 |
| 14 | DCsubaddrs | Text/120 |
| 15 | DCsubaddrs2 | Text/120 |
| 16 | DCsubcity | Text/27 |
| 17 | DCsubstate | Text/40 |
| 18 | DCsubzip | Text/10 |
| 19 | DCsubdaterep | Date/8 |
| 20 | DCsubsegdc | Text/2 |
| 21 | DCsubmarket | Text/4 |
| 22 | DCsubcontact | Text/1 |
| 23 | DCsubfbcode | Text/1 |

| Delinquency Alert Segment: DL | | Type/Size |
|---|---|---|
| 1 | DLsegid | Text/4 |
| 2 | DLsourcesegid | Text/4 |
| 3 | DLbureauhitlevelid | Text/10 |
| 4 | DLdedupflag | Num/1 |
| 5 | DLdedupids | Text/250 |
| 6 | DLproduct | Code = Text/50 |
| 6 | DLproduct (cont) | Code = Text/50 |
| 7 | DLscore | Text/25 |
| 8 | DLsign | Text/1 |
| 9 | DLreason1 | Code = Text/105 |
| 10 | DLreason2 | Code = Text/105 |
| 11 | DLreason3 | Code = Text/105 |
| 12 | DLreason4 | Code = Text/105 |
| 13 | DLreject | Code = Text/1 00 |
| 14 | DLprodstat | Code = Text/70 |
| 15 | DLmodcharid | Text/8 |
| 16 | DLmodcharv | Text/10 |
| Employment Segment: EM | | Type/Size |
| 1 | EMsegid | Text/4 |
| 2 | EMsourcesegid | Text/4 |
| 3 | EMbureauhitlevelid | Text/10 |
| 4 | EMdedupflag | Num/1 |
| 5 | EMdedupids | Text/250 |
| 6 | EMname | Text/35 |
| 7 | EMqualifier | Text/1 |
| 8 | EMparseind | Text/1 |
| 9 | EMstreet | Text/48 |
| 10 | EMstreet2 | Text/32 |
| 11 | EMhouse | Text/10 |
| 12 | EMpredirect | Text/2 |
| 13 | EMstreetname | Text/27 |
| 14 | EMpostdirect | Text/2 |
| 15 | EMstreettype | Text/2 |
| 16 | EMapart | Text/5 |
| 17 | EMcityonly | Text/32 |
| 18 | EMstate | Text/2 |
| 19 | EMzip | Text/10 |
| 20 | EMadrsourceind | Text/1 |
| 21 | EMadrdaterep | Date/8 |
| 22 | EMoccupation | Text/35 |
| 23 | EMdatehired | Date/8 |
| 24 | EMdateleft | Date/8 |
| 25 | EMincome | Text/11 |
| 26 | EMpaybasis | Text/1 |
| 27 | EMdateveri | Date/8 |
| 28 | EMvericode | Text/1 |
| 29 | EMsourceind | Text/1 |
| 30 | EMphone | Text/10 |
| 31 | EMphoneext | Text/5 |
| 32 | EMphonesource | Text/1 |
| 33 | EMphonequal | Text/1 |
| 34 | EMphonetype | Text/2 |
| 35 | EMphoneavail | Text/10 |
| 36 | EMformer | Num/1 |
| | | 0 = current |
| | | 1 = former |
| | | 2 = 2^{nd} former |
| Error Segment: ER | | Type/Size |
| 1 | ERsegid | Text/4 |
| 2 | ERsourcesegid | Text/4 |
| 3 | ERbureauhitlevelid | Text/10 |
| 4 | ERdedupflag | Num/1 |
| 5 | ERdedupids | Text/250 |
| 6 | ERmsg | Code = Text/81 |

| Hit Level Segment: HI | | Type/Size |
|---|---|---|
| 1 | HIsegid | Text/4 |
| 2 | HIsourcesegid | Text/4 |
| 3 | HIbureauhitlevelid | Text/10 |
| 4 | HIdedupflag | Num/1 |
| 5 | HIdedupids | Text/250 |
| 6 | HIhitlevelinit | Text/2 |
| 7 | HIhitlevelmsg | Text/99 |
| 8 | HImessagecode | Text/6 |
| 9 | HIsourceind | Text/1 |
| 10 | HIidqual | Text/2 |
| 11 | HIssn | SSN/9 |
| 12 | HIssndatestart | Date/8 |
| 13 | HIssnyearscov | Text/2 |
| 14 | HIssnfirst | Date/8 |
| 15 | Hlssnlast | Date/8 |
| 16 | HIssnstateissued | Text/2 |
| 17 | HIssndateretired | Date/8 |
| 18 | HIssnstateretired | Text/2 |
| 19 | HIssndatebirth | Date/8 |
| 20 | HIssnsignagefirst | Text/1 |
| 21 | HIssnsignagelast | Text/1 |
| 22 | HIssnagefirst | Text/2 |
| 23 | HIssnagelast | Text/2 |
| 24 | HIssnstatus | Text/2 |
| 25 | HIssncount | Text/4 |
| 26 | HIssnerrorcode | Text/1 |
| 27 | HImiscyearscov | Text/2 |
| 28 | HImiscfirst | Date/8 |
| 29 | HImisclast | Date/8 |
| 30 | HIindicatorl | Text/2 |
| 31 | HIindicator2 | Text/2 |
| 32 | HIindicator3 | Text/2 |
| 33 | HIindicator4 | Text/2 |
| 34 | HIdateaddr | Date/8 |
| 35 | HIaddrcount | Text/4 |
| 36 | HIaddrerrorcode | Text/1 |
| 37 | HIaddrmatch | Text/1 |
| 38 | HIaddrind | Text/1 |
| 39 | HIaddress | Text/10 |
| 40 | HInoother | Text/3 |
| 41 | HIoccurtime | Text/2 |
| 42 | HIthreshold | Text/3 |

| Identification Segment: ID | | Type/Size |
|---|---|---|
| 1 | IDsegid | Text/4 |
| 2 | IDsourcesegid | Text/4 |
| 3 | IDbureauhitlevelid | Text/10 |
| 4 | IDdedupflag | Num/1 |
| 5 | IDdedupids | Text/250 |
| 6 | IDsubjectid | Num/1 |
| 7 | IDfirst | Text/15 |
| 8 | IDmiddle | Text/15 |
| 9 | IDlast | Text/25 |
| 10 | IDprefix | Text/3 |
| 11 | IDsuffix | Text/3 |
| 12 | IDgender | Text/1 |
| 13 | IDssn | SSN/11 |
| 14 | IDspouse | Text/58 |
| 15 | IDsssn | SSN/11 |
| 16 | IDage | Num/3 |
| 17 | IDdatebirth | Date/8 |
| 18 | IDdateonfile | Date/8 |
| 19 | IDdatelastacc | Date/8 |
| 20 | IDdatereport | Date/8 |
| 21 | IDdatedeceased | Date/8 |
| 22 | IDnamesource | Text/1 |
| 23 | IDnameind | Text/1 |
| 24 | IDproduct | Code = Text/50 |
| 25 | IDpersonalsource | Text/1 |
| 26 | IDfileno | Num/2 |
| 27 | IDfilehit | Text/1 |
| 28 | IDfraud | Text/1 |
| 29 | IDssnmatch | Text/2 |
| 30 | IDindicator | Text/50 |
| 31 | IDindicator2 | Text/50 |
| 32 | IDmarketfile | Text/2 |
| 33 | IDsubmarketfile | Text/2 |
| 34 | IDversion | Text/2 |
| 35 | IDcountry | Text/1 |
| 36 | IDlanguage | Text/1 |
| 37 | IDuserref | Text/24 |
| 38 | IDmarket | Text/4 |
| 39 | IDmember | Text/10 |
| 40 | IDreferral | Text/3 |
| 41 | IDdatetrans | Date/8 |
| 42 | IDtimetrans | Text/6 |
| 43 | IDecoa | Text/1 |
| 44 | IDoutputfmt | Text/2 |
| 45 | IDmthsinq | Text/1 |
| 46 | IDmthsMOP | Text/1 |
| 47 | IDaddmultip | Text/1 |
| 48 | IDsegcounters | Text/120 |
| 49 | IDbussoldata | Text/13 |
| 50 | IDdriverlic | Text/20 |
| Inquiry Segment: IQ | | Type/Size |
| 1 | IQsegid | Text/4 |
| 2 | IQsourcesegid | Text/4 |
| 3 | IQbureauhitlevelid | Text/10 |
| 4 | IQdedupflag | Num/1 |
| 5 | IQdedupids | Text/250 |
| 6 | IQdaterep | Date/8 |
| 7 | IQmember | Text/18 |
| 8 | IQmembername | Text/24 |
| 9 | IQecoa | Text/1 |
| 10 | IQloantype | Code = Text/75 |
| 11 | IQamount | Amount/9 |
| 12 | IQterms | Text/3 |
| 13 | IQkob | Text/2 |
| 14 | IQmarket | Text/4 |
| 15 | IQaccount | Text/40 |
| 16 | IQphone | Text/15 |

| Miscellaneous Segment: MI | | Type/Size |
|---|---|---|
| 1 | MIsegid | Text/4 |
| 2 | MIsourcesegid | Text/4 |
| 3 | MIbureauhitlevelid | Text/10 |
| 4 | MIdedupflag | Num/1 |
| 5 | MIdedupids | Text/250 |
| 6 | MImsg1 - MImsg7 | Text/120 |
| 6 | MImsg1 - MImsg7 (cont) | Text/120 |
| 6 | MImsg1 - MImsg7 (cont) | Text/120 |
| 6 | MImsg1 - MImsg7 (cont) | Text/120 |
| 6 | MImsg1 - MImsg7 (cont) | Text/120 |
| 6 | MImsg1 - MImsg7 (cont) | Text/120 |
| 6 | MImsg1 - MImsg7 (cont) | Text/120 |

| Public Records Segment: PU | | Type/Size |
|---|---|---|
| 1 | PUsegid | Text/4 |
| 2 | PUsourcesegid | Text/4 |
| 3 | PUbureauhitlevelid | Text/10 |
| 4 | PUdedupflag | Num/1 |
| 5 | PUdedupids | Text/250 |
| 6 | PUcourt | Text/60 |
| 7 | PUcourtname | Code = Text/80 |
| | | For XPN, EFX, contains |
| | | Name only |
| 8 | PUcourtcity | Text/27 |
| 9 | PUcourtstate | Text/2 |
| 10 | PUdocket | Text/60 |
| 11 | PUplaintiff | Text/75 |
| 12 | PUattorney | Text/60 |
| 13 | PUdefendant | Text/75 |
| 14 | PUgarnishee | Text/40 |
| 15 | PUtype | Code = Text/40 |
| 15 | PUtype (cont) | Code = Text/40 |
| 16 | PUtype 1 | Text/2 |
| 17 | PUtype2 | Text/2 |
| 18 | PUdaterep | Date/8 |
| 19 | PUdateveri | Date/8 |
| 20 | PUdatepaid | Date/8 |
| 21 | PUamount | Amount/42 |
| 22 | PUassets | Amount/10 |
| 23 | PUliab | Amount/10 |
| 24 | PUexempt | Amount/7 |
| 25 | PUecoa | Text/1 |
| 26 | PUcomment | Code = Text/255 |
| | | May be empty code field |
| 27 | PUcomment2 | Code = Text/255 |
| 28 | PUfbcode | Text/1 |
| 29 | PUeval | Text/1 |
| 30 | PUdispute | Text/1 |
| 31 | PUrepaypct | Text/3 |
| 32 | PUadjustpct | Text/2 |
| 33 | PUbookpage | Text/24 |
| 34 | PUvolinvol | Text/1 |
| 35 | PUdateorigfile | Date/8 |
| 36 | PUkob | Text/2 |

| Raw Segment: RW | | Type/Size |
|---|---|---|
| 1 | RWsegid | Text/4 |
| 2 | RWsourcesegid | Text/4 |
| 2 | RWsourcesegid (cont) | Text/4 |
| 2 | RWsourcesegid (cont) | Text/4 |
| 3 | RWbureauhitlevelid | Text/10 |
| 4 | RWdedupflag | Num/1 |
| 5 | RWdedupids | Text/250 |
| 6 | RWrawsegment | Text/5000 |
| 6 | RWrawsegment (cont) | Text/5000 |

| Summary Consumer Information | | |
|---|---|---|
| Segment: SUCI | | Type/Size |
| 1 | SUCIsegid | Text/4 |
| 2 | SUCIsourcesegid | Text/4 |
| 3 | SUCIbureauhitlevelid | Text/10 |
| 4 | SUCIdedupflag | Num/1 |
| 5 | SUCIdedupids | Text/250 |
| 6 | SUCIcategory | Text/2 |
| 7 | SUCI001 | Num/11 |
| 8 | SUCI002 | Num/11 |
| 9 | SUCI003 | Num/11 |
| 10 | SUCI004 | Num/11 |
| 11 | SUCI005 | Num/11 |
| 12 | SUCI006 | Num/11 |
| 13 | SUCI007 | Num/11 |
| 14 | SUCI008 | Num/11 |
| 15 | SUCI009 | Num/11 |
| 16 | SUCI010 | Num/11 |
| 17 | SUCI011 | Num/11 |
| 18 | SUCI012 | Num/11 |
| 19 | SUCI013 | Num/11 |
| 20 | SUCI014 | Num/11 |
| 21 | SUCI015 | Num/11 |
| 22 | SUCI016 | Num/11 |
| 23 | SUCI017 | Num/11 |
| 24 | SUCI018 | Num/11 |
| 25 | SUCI019 | Num/11 |
| 26 | SUCI020 | Num/11 |
| 27 | SUCI021 | Num/11 |
| 28 | SUCI022 | Num/11 |
| 29 | SUCI023 | Num/11 |
| 30 | SUCI024 | Num/11 |
| 31 | SUCI025 | Num/11 |
| 32 | SUCI026 | Num/11 |
| 33 | SUCI027 | Num/11 |
| 34 | SUCI028 | Num/11 |
| 35 | SUCI029 | Num/11 |
| 36 | SUCI030 | Num/11 |
| 37 | SUCI031 | Num/11 |
| 38 | SUCI032 | Num/11 |
| 39 | SUCI033 | Num/11 |
| 40 | SUCI034 | Num/11 |
| 41 | SUCI035 | Num/11 |
| 42 | SUCI036 | Num/11 |
| 43 | SUCI037 | Num/11 |
| 44 | SUCI038 | Num/11 |
| 45 | SUCI039 | Num/11 |
| 46 | SUCI040 | Num/11 |
| 47 | SUCI041 | Num/11 |
| 48 | SUCI042 | Num/11 |
| 49 | SUCI043 | Num/11 |
| 50 | SUCI044 | Num/11 |
| 51 | SUCI045 | Num/11 |
| 52 | SUCI046 | Num/11 |
| 53 | SUCI047 | Num/11 |
| 54 | SUCI048 | Num/11 |
| 55 | SUCI049 | Num/11 |
| 56 | SUCI050 | Num/11 |
| 57 | SUCI051 | Num/11 |
| 58 | SUCI052 | Num/11 |
| 59 | SUCI053 | Num/11 |
| 60 | SUCI054 | Num/11 |
| 61 | SUCI055 | Num/11 |
| 62 | SUCI056 | Num/11 |
| 63 | SUCI057 | Num/11 |
| 64 | SUCI058 | Num/11 |
| 65 | SUCI059 | Num/11 |
| 66 | SUCI060 | Num/11 |
| 67 | SUCI061 | Num/11 |
| 68 | SUCI062 | Num/11 |
| 69 | SUCI063 | Num/11 |
| 70 | SUCI064 | Num/11 |
| 71 | SUCI065 | Num/11 |
| 72 | SUCI066 | Num/11 |
| 73 | SUCI067 | Num/11 |
| 74 | SUCI068 | Num/11 |
| 75 | SUCI069 | Num/11 |
| 76 | SUC1070 | Num/11 |
| 77 | SUCI071 | Num/11 |
| 78 | SUCI072 | Num/11 |
| 79 | SUCI073 | Num/11 |
| 80 | SUCI074 | Num/11 |
| 81 | SUCI075 | Num/11 |
| 82 | SUCI076 | Num/11 |
| 83 | SUCI077 | Num/11 |
| 84 | SUCI078 | Num/11 |
| 85 | SUCI079 | Num/11 |
| 86 | SUCI080 | Num/11 |
| 87 | SUCI081 | Num/11 |
| 88 | SUCI082 | Num/11 |
| 89 | SUCI083 | Num/11 |
| 90 | SUCI084 | Num/11 |
| 91 | SUCI085 | Num/11 |
| 92 | SUCI086 | Num/11 |
| 93 | SUCI087 | Num/11 |
| 94 | SUCI088 | Num/11 |
| 95 | SUCI089 | Num/11 |
| 96 | SUCI090 | Num/11 |
| 97 | SUCI091 | Num/11 |
| 98 | SUCI092 | Num/11 |
| 99 | SUCI093 | Num/11 |
| 100 | SUCI094 | Num/11 |
| 101 | SUCI095 | Num/11 |
| 102 | SUCI096 | Num/11 |
| 103 | SUCI097 | Num/11 |
| 104 | SUCI098 | Num/11 |
| 105 | SUCI099 | Num/11 |
| 106 | SUCI100 | Num/11 |
| 107 | SUCI101 | Num/11 |
| 108 | SUCI102 | Num/11 |
| 109 | SUCI103 | Num/11 |
| 110 | SUCI104 | Num/11 |
| 111 | SUCI105 | Num/11 |
| 112 | SUCI106 | Num/11 |
| 113 | SUCI107 | Num/11 |
| 114 | SUCI108 | Num/11 |
| 115 | SUCI109 | Num/11 |
| 116 | SUCI110 | Num/11 |
| 117 | SUCI111 | Num/11 |
| 118 | SUCI112 | Num/11 |
| 119 | SUCI113 | Num/11 |
| 120 | SUCI114 | Num/11 |
| 121 | SUCI115 | Num/11 |
| 122 | SUCI116 | Num/11 |
| 123 | SUCI117 | Num/11 |
| 124 | SUCI118 | Num/11 |
| 125 | SUCI119 | Num/11 |
| 126 | SUCI120 | Num/11 |
| 127 | SUCI121 | Num/11 |
| 128 | SUCI122 | Num/11 |
| 129 | SUCI123 | Num/11 |
| 130 | SUCI124 | Num/11 |
| 131 | SUCI125 | Num/11 |
| 132 | SUCI126 | Num/11 |
| 133 | SUCI127 | Num/11 |
| 134 | SUCI128 | Num/11 |
| 135 | SUCI129 | Num/11 |
| 136 | SUCI130 | Num/11 |
| 137 | SUCI131 | Num/11 |
| 138 | SUCI132 | Num/11 |
| 139 | SUCI133 | Num/11 |
| 140 | SUCI134 | Num/11 |
| 141 | SUCI135 | Num/11 |
| 142 | SUCI136 | Num/11 |
| 143 | SUCI137 | Num/11 |
| 144 | SUCI138 | Num/11 |
| 145 | SUCI139 | Num/11 |
| 146 | SUCI130 | Num/11 |
| 147 | SUCI141 | Num/11 |
| 148 | SUCI142 | Num/11 |
| 149 | SUCI143 | Num/11 |
| 150 | SUCI144 | Num/11 |
| 151 | SUCI145 | Num/11 |
| 152 | SUCI146 | Num/11 |
| 153 | SUCI147 | Num/11 |
| 154 | SUCI148 | Num/11 |
| 155 | SUCI149 | Num/11 |
| 156 | SUCI150 | Num/11 |
| 157 | SUCI151 | Num/11 |
| 158 | SUCI152 | Num/11 |
| 159 | SUCI153 | Num/11 |
| 160 | SUCI154 | Num/11 |
| 161 | SUCI155 | Num/11 |
| 162 | SUCI156 | Num/11 |
| 163 | SUCI157 | Num/11 |
| 164 | SUCI158 | Num/11 |
| 165 | SUCI159 | Num/11 |
| 166 | SUCI160 | Num/11 |
| 167 | SUCI161 | Num/11 |
| 168 | SUCI162 | Num/11 |
| 169 | SUCI163 | Num/11 |
| 170 | SUCI164 | Num/11 |
| 171 | SUCI165 | Num/11 |
| 172 | SUCI166 | Num/11 |
| 173 | SUCI167 | Num/11 |
| 174 | SUCI168 | Num/11 |
| 175 | SUCI169 | Num/11 |
| 176 | SUCI170 | Num/11 |
| 177 | SUCI171 | Num/11 |
| 178 | SUCI172 | Num/11 |
| 179 | SUCI173 | Num/11 |
| 180 | SUCI174 | Num/11 |
| 181 | SUCI175 | Num/11 |
| 182 | SUCI176 | Num/11 |
| 183 | SUCI177 | Num/11 |
| 184 | SUCI178 | Num/11 |
| 185 | SUCI179 | Num/11 |
| 186 | SUCI180 | Num/11 |
| 187 | SUCI181 | Num/11 |
| 188 | SUCI182 | Num/11 |
| 189 | SUCI183 | Num/11 |
| 190 | SUCI184 | Num/11 |
| 191 | SUCI185 | Num/11 |
| 192 | SUCI186 | Num/11 |
| 193 | SUCI187 | Num/11 |
| 194 | SUCI188 | Num/11 |
| 195 | SUCI189 | Num/11 |
| 196 | SUCI190 | Num/11 |
| 197 | SUCI191 | Num/11 |
| 198 | SUCI192 | Num/11 |
| 199 | SUCI193 | Num/11 |
| 200 | SUCI194 | Num/11 |
| 201 | SUCI195 | Num/11 |
| 202 | SUCI196 | Num/11 |
| 203 | SUCI197 | Num/11 |
| 204 | SUCI198 | Num/11 |
| 205 | SUCI199 | Num/11 |
| 206 | SUCI200 | Num/11 |
| 207 | SUCI201 | Num/11 |
| 208 | SUCI202 | Num/11 |
| 209 | SUCI203 | Num/11 |
| 210 | SUCI204 | Num/11 |
| 211 | SUCI205 | Num/11 |

| Tradeline Segment: TR | | Type/Size |
|---|---|---|
| 1 | TRsegid | Text/4 |
| 2 | TRsourcesegid | Text/4 |
| 3 | TRbureauhitlevelid | Text/10 |
| 4 | TRdedupflag | Num/1 |
| 5 | TRdedupids | Text/250 |
| 6 | TRmember | Text/10 |
| 7 | TRkob | Text/12 |
| 8 | TRmembername | Text/40 |
| 9 | TRaccount | Text/50 |
| 10 | TRindicator | Text/36 |
| 11 | TRstatus | Code = Text/140 |
| 12 | TRloantype | Code = Text/85 |
| 13 | TRcomment | Code = Text/255 |
| 14 | TRcomment2 | Code = Text/255 |
| 15 | TRecoa | Text/1 |
| 16 | TRamount | Amount/9 |
| 17 | TRamounttype | Text/1 |
| 18 | TRamount2 | Amount/9 |
| 19 | TRamount2type | Text/1 |
| 20 | TRhighcredit | Amount/9 |
| 21 | TRcreditlimit | Amount/9 |
| 22 | TRbalance | Amount/9 |
| 23 | TRpastdue | Amount/9 |
| 24 | TRpastdueno | Num/2 |
| 25 | TRmaxdelrate | Code = Text/70 |
| 26 | TRmaxdelamount | Amount/9 |
| 27 | TRdateopen | Date/11 |
| 28 | TRdaterep | Date/11 |
| 29 | TRdatebalance | Date/8 |
| 30 | TRdatemaxdel | Date/8 |
| 31 | TRdateclosed | Date/8 |
| 32 | TRdatelastpaid | Date/8 |
| 33 | TRpayprofile | Text/48 |
| 34 | TRcommonprofile | Text/48 |
| 35 | TRmonsrev | Num/3 |
| 36 | TRrawterms | Text/13 |
| 37 | TRmonthpayamt | Amount/9 |
| 38 | TRmonthpaytype | Text/1 |
| 39 | TR301ate | Num/2 |
| 40 | TR601ate | Num/2 |
| 41 | TR901ate | Num/2 |
| 42 | TRclosind | Text/1 |
| 43 | TRveriind | Code = Text/50 |
| 44 | TRaccounttype | Text/1 |
| 45 | TRdatestatus | Date/11 |
| 46 | TRprofilestartdate | Date/11 |
| 47 | TRcreditor | Text/38 |
| 48 | TRcollateral | Text/36 |
| 49 | TRdatelastact | Date/8 |
| 50 | TRdateverif | Date/8 |
| 51 | TRcurrency | Text/1 |
| 52 | TRhistverif | Text/1 |
| 53 | TRfbcode | Text/1 |
| 54 | TRdelinqrate1 | Text/1 |
| 55 | TRdatedelinq1 | Date/8 |
| 56 | TRdelinqrate2 | Text/1 |
| 57 | TRdatedelinq2 | Date/8 |
| 58 | TRdelinqrate3 | Text/1 |
| 59 | TRdatedelinq3 | Date/8 |
| 60 | TRsourceind | Text/1 |
| 61 | TRdatepaydue | Date/8 |
| 62 | TRballpayamt | Amount/9 |
| 63 | TRfreq | Text/1 |
| 64 | TRsoldto | Text/30 |
| 65 | TRdispute | Text/1 |
| 66 | TRdateinitpay | Date/11 |
| 67 | TRacctcond | Text/2 |
| 68 | TRpaystatus | Text/15 |
| 69 | TRtypecode | Tex/2 |

| Checksum Segment: CK | | Type/Size |
|---|---|---|
| 1 | CKsegid | Text/4 |
| 2 | CKnosegments | Num/4 |
| 3 | CKnocharacters | Num/5 |
| 4 | CKchecksum | Num/13 |

What is claimed is:

1. A method for processing credit applications, comprising the steps of:
receiving a credit request including consumer identification data;
receiving credit report data corresponding to the consumer identification data;
organizing the credit report data to form formatted credit report data;
removing consumer identification data from the formatted credit report data and credit request data to form anonymized credit data;
appending pre-defined application data, credit report data, and credit request data characteristics;
encrypting the anonymized credit data to form an encrypted credit file;
transmitting the encrypted credit file to a lending institution; and
receiving a response indicating credit approval corresponding to the encrypted credit file.

2. The method of claim 1, wherein the steps of transmitting are performed via a telephone line.

3. The method of claim 1, wherein the steps of transmitting are performed via an open network connection.

4. The method of claim 1, wherein the steps of transmitting are performed via a closed network connection.

5. The method of claim 1, wherein the steps of transmitting are performed via wireless communication.

6. The method of claim 1, wherein the steps of transmitting are performed via facsimile.

7. The method of claim 1, wherein the consumer identification data comprises the consumer's name.

8. The method of claim 1, wherein the consumer identification data comprises the consumer's gender.

9. The method of claim 1, wherein the consumer identification data comprises the consumer's address.

10. The method of claim 1, wherein the consumer identification data comprises the consumer's taxpayer identification number.

11. The method of claim 1, wherein the credit report comprises a data file from a credit bureau.

12. The method of claim 1, wherein the predetermined format comprises specific transaction information.

13. The method of claim 1, wherein the predetermined format comprises predefined summary characteristic information.

14. The method of claim 1, wherein the encrypting comprises encrypting using an Advanced Encryption Standard (AES) algorithm.

15. A system for processing credit applications, comprising:
means for receiving a credit request including consumer identification data;
means for receiving credit report data corresponding to the consumer identification data;
means for organizing the credit report data to form formatted credit report data;
means for removing consumer identification data from the formatted credit report data and credit request data to form anonymized credit data;
means for appending pre-defined application, credit report and credit request data characteristics;
means for encrypting the anonymized credit data to form an encrypted credit file;
means for transmitting the encrypted credit file to a lending institution; and
means for receiving a response indicating credit approval corresponding to the encrypted credit file.

16. The system of claim 15, wherein the steps of transmitting are performed via a telephone line.

17. The system of claim 15, wherein the steps of transmitting are performed via an open network connection.

18. The system of claim 15, wherein the steps of transmitting are performed via a closed network connection.

19. The system of claim 15, wherein the steps of transmitting are performed via wireless communication.

20. The system of claim 15, wherein the steps of transmitting are performed via facsimile.

21. The system of claim 15, wherein the consumer identification data comprises the consumer's name.

22. The system of claim 15, wherein the consumer identification data comprises the consumer's gender.

23. The system of claim 15, wherein the consumer identification data comprises the consumer's address.

24. The system of claim 15, wherein the consumer identification data comprises the consumer's taxpayer identification number.

25. The system of claim 15, wherein the credit report comprises a data file from a credit bureau.

26. The method of claim 15, wherein the predetermined format comprises specific transaction information.

27. The method of claim 15, wherein the predetermined format comprises predefined summary characteristic information.

28. The method of claim 15, wherein the encrypting is Advanced Encryption Standard (AES) or other similar encryption/decryption algorithms.

29. A computer program product, comprising:
a memory having computer-readable code embodied therein for processing credit applications comprising:
a code means for receiving a credit request including consumer identification data;
a code means for receiving credit report data corresponding to the consumer identification data;
a code means for organizing the credit report data to form formatted credit report data;
a code means for removing consumer identification data from the formatted credit report data and credit request data to form anonymized credit data;
a code means for appending pre-defined application, credit report and credit request data characteristics;
a code means for encrypting the anonymized credit data to form an encrypted credit file;
a code means for transmitting the encrypted credit file to a lending institution; and
a code means for receiving a response indicating credit approval corresponding to the encrypted credit file.
